(19) United States
(12) Patent Application Publication
(10) Pub. No.: US 2019/0098135 A1
(43) Pub. Date: Mar. 28, 2019

(54) System, Method, and Apparatus for Determining a Status of a Call Recipient in a Call System

(71) Applicant: Joseph Charlson, Pittsburgh, PA (US)

(72) Inventor: Joseph Charlson, Pittsburgh, PA (US)

(21) Appl. No.: 16/204,147

(22) Filed: Nov. 29, 2018

Related U.S. Application Data
(63) Continuation of application No. 15/417,603, filed on Jan. 27, 2017.
(60) Provisional application No. 62/287,563, filed on Jan. 27, 2016.

(51) Int. Cl. H04M 3/51; G10L 15/08; H04M 3/42; G10L 15/22

(52) U.S. Cl. CPC H04M 3/5175; G10L 15/08; H04M 3/5166; H04M 3/42221; G10L 2015/223; H04M 2203/5018; H04M 2203/2011; H04M 2201/40; G10L 15/22

(57) ABSTRACT

Provided is a computer-implemented method for determining a status of a call during a phone call between a call agent and the call recipient over a two-party phone line. The method includes automatically adding a third-party phone line to the two-party phone line, the third-party phone line in communication with a call monitoring computer, monitoring, by the call monitoring computer over the second phone line, the phone call between the call recipient and the call agent, detecting, by the call monitoring computer, a predefined response from at least one of the call recipient and the call agent over the phone call, and automatically initiating a customer service action in response to detecting the predefined response. Further provided is a computer-implemented method for processing phone calls based on predetermined call duration thresholds.

### CROSS REFERENCE TO RELATED APPLICATIONS

This application is a continuation of U.S. patent application Ser. No. 15/417,603, filed on Jan. 27, 2017, which claims the benefit of priority to U.S. Provisional Patent Application No. 62/287,563, filed on Jan. 27, 2016, the entire contents of which are hereby incorporated by reference.

### BACKGROUND OF THE INVENTION

### 1. Field of the Invention

This invention relates generally to call systems and, in particular, systems, methods, and computer program products for determining a status of a call recipient during or after phone calls.

### 2. Technical Considerations

Existing call systems rely on call agents to comply with individuals' requests, such as being added to a do-not-call list or forwarded to a supervisor, filing a complaint, or providing quality feedback, as examples. Often, call recipients are tasked with pressing a key or verbally stating their intentions through an Interactive Voice Response (IVR) system or while talking to a live call agent.

Managing a do-not-call list can be particularly difficult in call distribution systems where the call agents may be from numerous different call-buying entities and therefore may not use a uniform list or process. For example, an individual may receive or initiate a call from a first call agent with regard to goods or services for a particular provider. The individual may request to be added to a do-not-call list, in response to which the first call agent or the IVR system may not comply. The individual may then, at a later time, receive a call from the original call marketing entity or from a second call agent from a different call-buying entity with regard to the same goods or services for the same provider. Frustrated call recipients may ask why another call was received after asking to be added to a do-not-call list but, in some instances, the different call-buying entities have no record of the previous call received by that individual due to the distributed nature of call marketing networks.

Moreover, some entities analyze call recordings after the call takes place to determine if the call recipient should be added to a do-not-call list or if some other action should take place. Analyzing every call recording can be process and labor intensive and, as a result, costly.

These difficulties with prior art systems not only cause frustration among call recipients, but also negatively affect subsequent call-buyers that are expending time and/or resources on calls to leads that have already been contacted with negative results.

### SUMMARY OF THE INVENTION

It is an object of the present invention to provide a system, method, and computer program product for determining a status of a call recipient during calls that overcomes some or all of the deficiencies of the prior art.

According to a non-limiting embodiment, provided is a computer-implemented method for determining a status of a call recipient during a phone call between a call agent and the call recipient over a two-party phone line, comprising: automatically adding a third-party phone line to the two-party phone line, the third-party phone line in communication with a call monitoring computer; monitoring, by the call monitoring computer over the third-party phone line, the phone call; detecting, by the call monitoring computer, a predefined response from at least one of the call recipient and the call agent over the three-party phone call; and automatically initiating a customer service action in response to detecting the predefined response.

In some non-limiting embodiments, the third-party phone line may be added to the phone call in response to an automated call system forwarding the phone call to the call agent. Further, in some embodiments, the customer service action may comprise at least one of the following: adding a telephone number to an internal do-not-call list, adding a telephone number to an external do-not-call list, alerting a customer service representative, alerting a supervisor, logging an event in a database, or any combination thereof. The predefined response may include, for example, at least one key press, a predetermined sequence of a plurality of key presses, and/or an audible phrase or term from a predefined set of phrases and terms.

In some embodiments, monitoring the call comprises analyzing audio signals from the call agent and/or call recipient to identify the audible phrase or terms. Further, the call monitoring computer may initiate the customer service action. In some examples, the phone call is initiated or received through a call computer, and the customer service action is initiated by at least one of the call computer and the call monitoring computer. Moreover, the predefined response may be detected from a plurality of predefined responses, each predefined response of the plurality of predefined responses corresponding to at least one customer service action.

According to another non-limiting embodiment, provided is a system for determining a status of a call recipient during a phone call between a call agent and the call recipient over a first two-party phone connection, comprising at least one computer including at least one processor programmed or configured to: automatically add a third-party phone line to the two-party phone connection, the third-party phone line in communication with a call monitoring computer; monitor, over the third-party phone line, the phone call; detect a predefined response from at least one of the call recipient and the call agent over the phone call; and automatically initiate a customer service action in response to detecting the predefined response.

In some non-limiting embodiments, the at least one computer may comprise the call monitoring computer. Moreover, in some non-limiting embodiments, the third-party phone line is added to the phone call in response to an automated call system forwarding the phone call to the call agent. The customer service action may comprise at least one of the following: adding a telephone number to an internal do-not-call list, adding a telephone number to an external do-not-call list, alerting a customer service representative, alerting a supervisor, logging an event in a database, or any combination thereof. The predefined response may include, for example, at least one key press, a predetermined sequence of a plurality of key presses, and/or an audible phrase or term from a predefined set of phrases and terms.

In non-limiting embodiments, monitoring the phone call may comprise analyzing audio signals from the phone call to identify the audible phrase or term. Further, in some examples, the at least one computer may comprise a call monitoring computer and a call computer, wherein the phone call is initiated or received through the call computer, and wherein at least one of the call monitoring computer and the call computer is programmed or configured to: monitor the third-party phone line; detect the predefined response from at least one of the individual and the call agent over the phone call; and initiate the customer service action. In some embodiments, the predefined response may be detected from a plurality of predefined responses, each predefined response of the plurality of predefined responses corresponding to at least one customer service action.

According to a further non-limiting embodiment, provided is a computer-implemented method for determining a status of a call recipient after a phone call between a call agent and the call recipient over a first phone line, comprising: automatically recording the phone call, resulting in a call recording having a duration; determining, with a call recording processing system, if the duration of the call recording exceeds a first predetermined call duration and is less than a second predetermined call duration; in response to determining that the duration exceeds the first predetermined call duration and is less than the second predetermined call duration, determining if the call recording comprises at least one predefined response by analyzing the call recording; and in response to determining that the call recording comprises the at least one predefined response, initiating at least one customer service action.

According to another non-limiting embodiment, provided is a computer-implemented method for determining a status of a call recipient during a phone call between a call agent and the call recipient over a two-party phone line, comprising: monitoring, with a call monitoring computer, the two-party phone line; detecting, by the call monitoring computer, a predefined key sequence from the call agent over the two-party phone line; and automatically generating a do-not-call request based at least partially on an identification of the call recipient in response to detecting the predefined key sequence.

According to another non-limiting embodiment, provided is a method for determining a status of a call recipient during a phone call between a call agent and the call recipient over a two-party phone line, comprising: monitoring, with a call monitoring computer, the two-party phone line; detecting, by the call monitoring computer, a predefined statement from the call recipient over the two-party phone line; and automatically generating a do-not-call request based at least partially on an identification of the call recipient in response to detecting the predefined statement. In some non-limiting embodiments, the call recording processing system may determine if the call recording comprises the at least one predefined response by analyzing the call recording.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic diagram for a system for determining a status of a call recipient during a call according to the principles of the present invention;

FIG. 2 is a flow diagram for a method for determining a status of a call recipient during a call according to the principles of the present invention;

FIG. 3 is a schematic diagram for a system for determining a status of a call recipient after a call according to the principles of the present invention; and

FIG. 4 is a flow diagram for a method for determining a status of a call recipient after a call according to the principles of the present invention.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that may be wired and/or wireless in nature. Additionally, two units or components may be in communication with each other even though the data transmitted may be modified, processed, and/or routed between the first and second unit or component. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

In a preferred and non-limiting embodiment, provided is a system and method for determining a status of a call recipient in a call distribution system. During a call between a call agent and an individual over an outbound line or a derivate inbound call from the original call recipient, a monitoring line (e.g., a third-party line) is added to the call. The monitoring line is in communication with a call monitoring computer which detects a predefined response from the call agent and/or call recipient. The predefined response may be, for example, a key press or sequence of key presses inputted by the agent to place the call recipient on a do-not-call list or take some other action. The call monitoring computer detects the predefined response over the monitoring line and initiates a corresponding customer service action, such as adding the telephone number of the call recipient to a do-not-call list. As explained herein, numerous other variations are possible.

The terms “do-not-call list” and “do-not-call registry,” as used herein, refer to any listing, database, schema, and/or system for maintaining telephone numbers and/or caller identification information for individuals, households, or businesses, including lists or registries that are maintained and/or operated internally by a call center, externally by a third party or governmental agency, or the like. In a preferred and non-limiting embodiment, a do-not-call registry is a system or entity that maintains a listing (e.g., a do-not-call list) of telephone numbers and/or other call identification information for individuals, households, or businesses that do not wish to receive telephone solicitations.

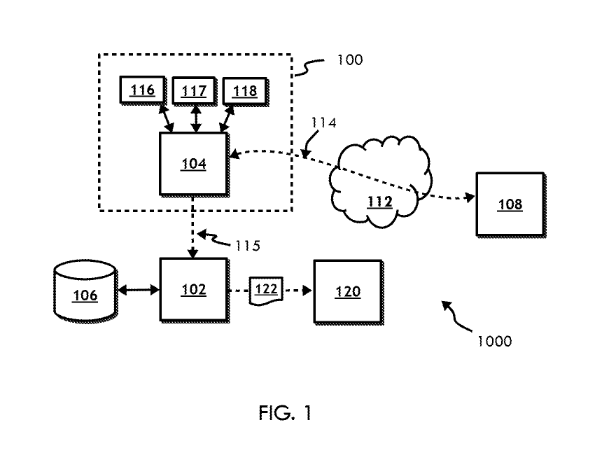

Referring now to FIG. 1, a system 1000 for determining a status of a call recipient during a call between a call agent and a call recipient is shown according to a preferred and non-limiting embodiment. A call center 100 includes a telephone switch 104 in communication with call agents 116, 117, 118. The telephone switch 104 is also in communication with a Public Switched Telephone Network (PSTN) 112 and, through the PSTN 112, one or more user telephones 108 over a line 114. The line 114 may be a “plain old telephone service” (POTS) line or, in other examples, may be a network connection through the Internet, a Session Initiation Protocol (SIP) provider or any other network environment. It will be appreciated that various other arrangements are possible. For example, instead of using a telephone switch 104, the call agents 116, 117, 118 may be in communication with the line 114 directly or through individual call computers.

With continued reference to FIG. 1, a call agent 116 may initiate an outbound call with the user telephone 108 in any number of ways. In a preferred and non-limiting embodiment, the telephone switch 104 comprises one or more Interactive Voice Response (IVR) systems, including one or more computers programmed or configured to place automated outbound calls to a plurality of leads (e.g., individual call recipients). During the automated calls, prerecorded and/or dynamically generated messages may be presented to the call recipient of the user telephone 108. The IVR system may present an audible prompt to the call recipient for requesting a live call agent or, in other examples, may automatically connect a live call agent to the call recipient. In some non-limiting embodiments, the call may be a derivative inbound call rather than an outbound call.

Still referring to FIG. 1, the system 1000 further includes a call monitoring computer 102 in communication with the telephone switch 104 via a monitoring line 115. The call monitoring computer 102 is in communication with a data storage device 106, such as a hard drive. The call monitoring computer 102, through the monitoring line 115, may monitor audio and/or other signals being transmitted over the line 114. It will be appreciated that the monitoring line 115 may monitor the line 114 in any number of ways. For example, the monitoring line may be “patched in” or conferenced through the telephone switch 104 or any other system, device, or telephony application programming interface. The monitoring line 115 may be added to the call at any time during the call. In a preferred and non-limiting embodiment, the monitoring line 115 is added to the outbound call or derivative inbound return call in response to a call recipient being connected with a live call agent 116 or requesting a live call agent 116. However, it will be appreciated that the monitoring line 115 may be added when the call is first established, upon an action performed by the call agent 116 and/or call recipient, and/or the like. Moreover, a prerecorded warning may be presented to the call recipient before or upon adding the monitoring line 115, informing the call recipient that the call may be monitored and/or recorded.

After the monitoring line 115 is added to the phone call, one or more software applications executing on the call monitoring computer 102 may analyze audio and/or other signals transmitted over the line 114. In a preferred and non-limiting embodiment, the call monitoring computer 102 may be programmed or configured to detect a predefined response from the call agent 116 and/or call recipient. The predefined response may be, for example, one or more tones such as Dual Tone Multi Frequency (DTMF) tones that result from telephone key presses. In one such example, a call agent may input a predefined response such as a key sequence (e.g., “1,” “2,” “3”) that is detectable by the call monitoring computer 102. In another example, the predefined response may be a single key press (e.g., “1” or “#”), a repeated key press (e.g., “1, 1, 1” or “#, #, #”) or a multiple key press sequence (e.g. “7, 8, 9”). For example, the predefined response may be a predetermined number of key presses over a predetermined time period (e.g., three (3) presses of “6” within ten (10) seconds). Using a repeated key press or a sequence of key presses as a predefined response helps reduce false indications resulting from errant keypresses.

In non-limiting embodiments, the predefined response may also be one or more detected words, phrases, and/or sentiments. As an example, the call monitoring computer 102 may be programmed or configured to perform natural language processing on the audio transmitted over the line 114. Those skilled in the art will appreciate that any known natural language processing techniques may be used. The detected words and/or phrases may be predefined statements such as, for example, expletives, “remove me,” “do not call,” and/or the like. The detected sentiment may include anger, frustration, stress, and/or the like, and may be detected by any method of analyzing vocal waveforms and/or speech patterns known to those skilled in the art. In some non-limiting embodiments, artificial intelligence and/or machine learning techniques may be used by the call monitoring computer 102 to analyze the audio over the line 114. In some examples, there may be several different predefined responses that correspond to the same or separate customer service actions.

Still referring to FIG. 1, the data storage device 106 includes one or more databases defining the one or more predefined responses. The data storage device 106 may also record all or a portion of the call. Moreover, in non-limiting embodiments, the call monitoring computer 102 may record an event log or other similar data structure embodied in the data storage device 106 for each detection of a predefined response. As an example, the event log may associate detections of predefined responses with an identification of a call agent 116 and/or a call recipient, audio captured from the call, a time and date, an identification of a particular call center 100, and/or other like information.

In response to detecting a predefined response, the call monitoring computer 102 may initiate one or more customer service actions. In a preferred and non-limiting example, the customer service action includes adding the call recipient to a do-not-call list or registry. For example, and with reference to FIG. 1, upon detecting a predefined response over the monitoring line 115, the call monitoring computer 102 may be programmed or configured to generate and transmit a do-not-call request 122 to a do-not-call registry 120. The do-not-call request 122 may include one or more data packets, messages, and/or other like data structures that identify the call recipient's telephone number and other information. The do-not-call request 122 may be transmitted to the do-not-call registry 120 over a network connection, over a telephone line, and/or the like. Additionally or alternatively, it will be appreciated that the do-not-call request 122 may also be transmitted to the call center 100 for inclusion on an internal do-not-call list maintained by the call center 100, or to a third-party or government agency.

In non-limiting embodiments, the customer service action initiated in response to detecting a predefined response may also include, as examples, alerting or notifying a customer service representative, alerting or notifying a supervisor, logging an event in a database stored in the data storage device 106, or any other customer service action responsive to a request or response by a call agent 116, call recipient, and/or call monitoring computer 102.

In non-limiting embodiments, the system 1000 may be arranged in various ways. For example, the call monitoring computer 102 and/or data storage device 106 may be local and/or remote to the call center 100. Further, the monitoring line 115 may be added by a call agent 116 computer at the call center 100 through one or more software applications. In a non-limiting embodiment, a software application (or “app”) may be provided within an operating system or as a plug-in or add-on to a software system used by the call center 100. In other examples, a standalone software application may be executed by a call agent 116 computer and/or the telephone switch 104.

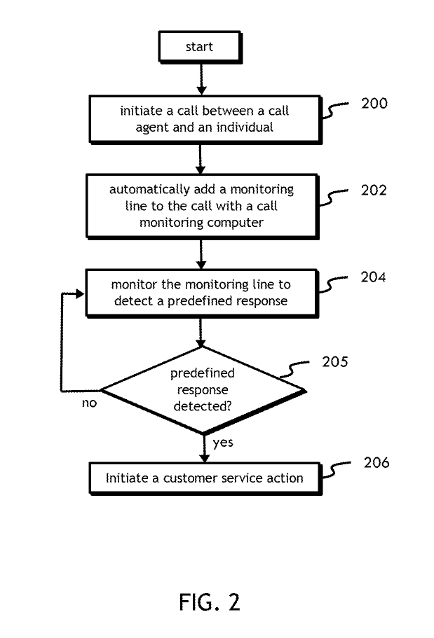

Referring now to FIG. 2, a method for determining a status of an individual during a call between a call agent and a call recipient is shown according to a preferred and non-limiting embodiment. At a first step 200, a phone call is initiated between a call agent and an individual. The phone call may be a cold call, a transferred call, and/or an automated call that is transferred to a call agent. It will also be appreciated that, in some non-limiting embodiments, the call may be entirely automated and a live call agent may not be involved. In some non-limiting embodiments, and as described herein, all parties to the call may be informed that the call may be recorded or monitored for quality assurance purposes. At a second step 202, a monitoring line in communication with a call monitoring computer is automatically added to the call. As explained herein, the monitoring line may be added in response to a call being transferred to a live agent, in response to the call being initiated, or at any other time during the call.

With continued reference to FIG. 2, at a next step 204, the monitoring line is monitored to detect one or more predefined responses by a call agent and/or call recipient. At step 205, the call monitoring computer determines if a predefined response is detected. If a predefined response is not detected, the method proceeds back to step 204 and the call monitoring computer continues to monitor the monitoring line. If a predefined response is detected, the method proceeds to step 206 in which a customer service action is initiated. The customer service action may be based on the predefined response detected and may include, for example, adding the call recipient to a do-not-call list or alerting a call agent supervisor.

In non-limiting embodiments, telephonic interactions between an individual and a call agent may be recorded, either by the call monitoring computer or by some other system or device, and analyzed at a later time after the call takes place. For example, a call recording may be processed with a call recording processing system which may include one or more computers, including one or more processors and software applications. The call recording processing system may execute voice recognition analysis software implementing natural language processing methodologies to detect instances of predefined statements such as, for example, expletives, “remove me,” “do not call,” “DNC,” “stop calling me,” “not interested,” “wrong number,” and/or the like. Further, the call recording may be analyzed for a detected sentiment such as, for example, anger, frustration, stress, and/or the like, which may be detected by any method of analyzing vocal waveforms and/or speech patterns known to those skilled in the art. Even further, the call recording may be analyzed to detect instances of predefined statements from the call agent that may be indicative of fraudulent activity on behalf of the call agent, e.g., “call you back,” “busy,” or other statements that may be used to cut off a call prior to it reaching a billable call duration so that the call-buyer can circumvent the call-buying process and call back the lead at a later time. It will be appreciated that various other predefined statements and/or sentiments may be detected.

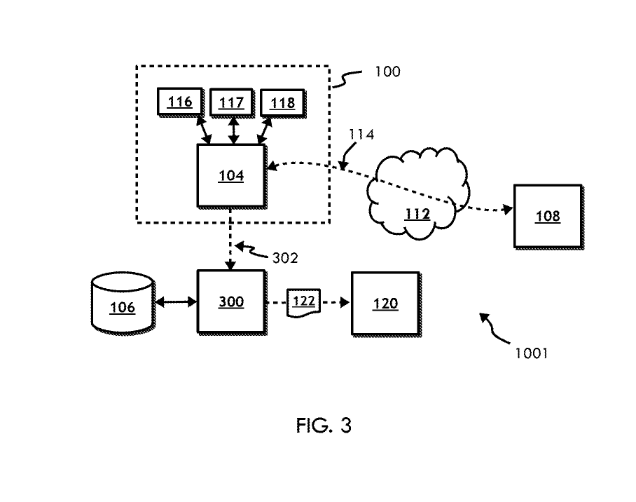

Referring now to FIG. 3, a system 1001 for determining a status of a call recipient after a call between a call agent 116, 117, 118 and a call recipient 108 is shown according to a preferred and non-limiting embodiment. The telephone switch 104, through a recording line 302, is in communication with a call recording processing system 300 which may include, for example, one or more computers including one or more processors and software applications. The call recording processing system 300 may record each call from or to the call center 100 (and possibly multiple call centers) and store the audio data for the call recordings in the data storage device 106. The call recording processing system 300 may then analyze the call recordings after the call is commenced or completed. For example, the analysis may begin at an interval or delay after the call begins and continue during the call or, in other examples, may begin at a time after the call is completed. If the call recording processing system 300 detects a predefined statement in the analyzed call recording, it may then initiate a customer service action, such as generating and transmitting a do-not-call request 122 to a do-not-call registry 120.

In some non-limiting embodiments, and with continued reference to FIG. 3, only certain call recordings may be analyzed after the call takes place to preserve system resources. For example, in response to determining that a call duration does not meet a predetermined billable call duration (e.g., a duration that a call has to last in order to be billable to a call-buyer) or some other predetermined minimum duration, the corresponding call recording may be analyzed by the call recording processing system 300 for predefined statements or sentiments. In other non-limiting embodiments, after the call recording processing system 300 determines that the call duration does not meet the predetermined minimum duration, the call recording may be forwarded or queued for manual review by a human operator. The human operator may then review and analyze the call recording to determine if a customer service action needs to take place. The predetermined billable call duration or other predetermined minimum duration may be predefined or, in other examples, may be dynamically determined prior to the call taking place. Call recordings corresponding to calls having a duration that exceed such a predetermined duration threshold may therefore not be analyzed.

Still referring to FIG. 3, in some non-limiting embodiments, the call recordings that are analyzed may be further filtered by other parameters prior to being analyzed. In some embodiments, only calls having a duration that exceed a first predetermined duration but are less than the predetermined billable call duration or other predetermined minimum duration may be analyzed. For example, if a first predetermined call duration is 10 seconds and the predetermined minimum call duration is 60 seconds, the call recording processing system 300 system may automatically route calls lasting less than or equal to 10 seconds (i.e., the first predetermined call duration) into a courtesy callback process to call the lead back and ask if they still need help. Recordings corresponding to calls exceeding 10 seconds (i.e., the first predetermined call duration) and less than or equal to 60 seconds (i.e., the predetermined minimum call duration) may be automatically analyzed by the call recording processing system 300 or forwarded to and/or queued for analysis by a human operator. If a predefined statement or sentiment is detected on the call recording, the call recording processing system 300 and/or human operator may initiate a customer service action, such as generating a do-not-call request 122 and communicating it to a do-not-call registry 120. In some examples, the lead (e.g., the call recipient) may be associated with a do-not-call status at the call center 100. The remaining calls falling within this call duration range may be either routed into the courtesy callback process or manually reviewed. It will be appreciated that the threshold values for the first predetermined call duration and the predetermined minimum call duration may be met by a call duration that is less than, less than or equal to, greater than, and/or greater than or equal to the thresholds. As used herein, “less than” may include values that are less than or less than or equal to a base value, and “exceeds” or “meets or exceeds” may include values that are greater than or equal to a base value. Moreover, although FIG. 3 shows the call recording processing system 300 located outside of the call center 100, it will be appreciated that it may also be implemented within the call center 100. Other arrangements are possible.

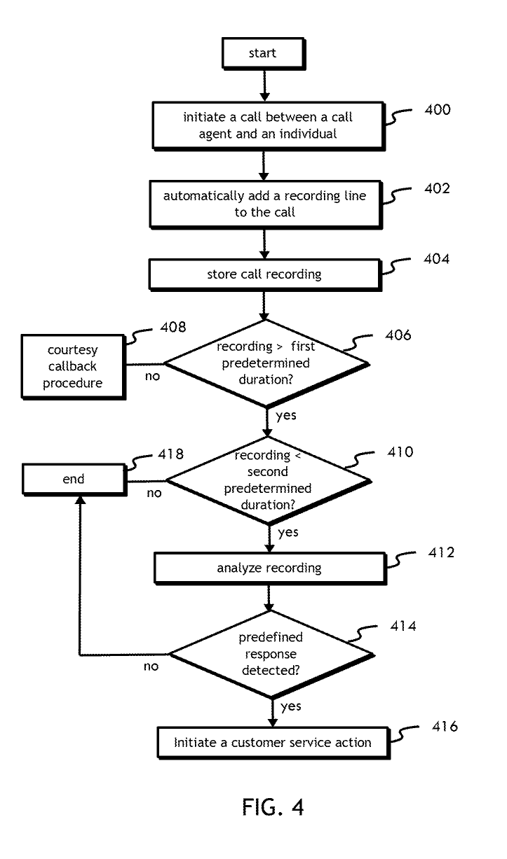

Referring now to FIG. 4, a method for determining a status of a call recipient after a call between a call agent and a call recipient is shown according to a preferred and non-limiting embodiment. At a first step 400, a call is initiated between a call agent and an individual. The call may be a cold call, an inbound call, a transferred call, and/or an automated call that is transferred to a call agent. It will also be appreciated that, in some non-limiting embodiments, the call may be entirely automated and a live call agent may not be involved. In some non-limiting embodiments, and as described herein, all parties to the call may be informed that the call may be recorded or monitored for quality assurance purposes. At a second step 402, a recording line in communication with a call recording processing system is automatically added to the call. The recording line may be added in response to a call being transferred to a live agent, in response to the call being initiated, or at any other time during the call. At step 404, the call recording is stored in at least one data storage device.

Still referring to FIG. 4, at a next step 406, it is determined whether the duration of the call recording (or of the call itself) meets or exceeds a first predetermined duration. If the call duration does not meet or exceed the first predetermined duration, the method may proceed to step 408 in which a courtesy callback procedure is implemented. If the call duration does meet or exceed the first predetermined duration, the method proceeds to step 410 in which it is determined if the duration of the call recording (or of the call itself) is less than a predetermined minimum call duration (such as but not limited to a predetermined billable call duration). If the call duration meets or exceeds a second predetermined minimum call duration, the method may end at step 418. If the call duration is greater than or equal to the first predetermined duration and less than the second predetermined minimum call duration, the method may proceed to step 412 in which the call recording is analyzed by a call recording processing system or a human operator. At step 414, it is determined, based on the analysis of the recording, whether a predefined response is detected. If a predefined response is not detected, the method may end at step 418 or proceed to a manual review. If a predefined response is detected at step 414, the method may proceed to step 416 in which a customer service action is implemented. For example, a do-not-call request may be generated and the call recipient may be added to a do-not-call registry.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for determining a status of a call recipient during a phone call between a call agent and the call recipient over a two-party phone line, comprising:
automatically adding a third-party phone line to the two-party phone line, the third-party phone line in communication with a call monitoring computer;
monitoring, by the call monitoring computer over the third-party phone line, the phone call;
detecting, by the call monitoring computer, a predefined response from at least one of the call recipient and the call agent over the three-party phone call; and
automatically initiating a customer service action in response to detecting the predefined response.

2. The computer-implemented method of claim 1, wherein the third-party phone line is added to the phone call in response to an automated call system forwarding the phone call to the call agent.

3. The computer-implemented method of claim 1, wherein the customer service action comprises at least one of the following: adding a telephone number to an internal do-not-call list, adding a telephone number to an external do-not-call list, alerting a customer service representative, alerting a supervisor, logging an event in a database, or any combination thereof.

4. The computer-implemented method of claim 1, wherein the predefined response comprises at least one key press.

5. The computer-implemented method of claim 4, wherein the at least one key press comprises a predetermined sequence of a plurality of key presses.

6. The computer-implemented method of claim 1, wherein the predefined response comprises an audible phrase or term from a predefined set of phrases and terms.

7. The computer-implemented method of claim 1, wherein monitoring the call comprises analyzing audio signals from the call agent and/or call recipient to identify an audible phrase or term.

8. The computer-implemented method of claim 1, wherein the call monitoring computer initiates the customer service action.

9. The computer-implemented method of claim 1, wherein the phone call is initiated or received through a call computer, and wherein the customer service action is initiated by at least one of the call computer and the call monitoring computer.

10. The computer-implemented method of claim 1, wherein the predefined response is detected from a plurality of predefined responses, each predefined response of the plurality of predefined responses corresponding to at least one customer service action.

11. A system for determining a status of a call recipient during a phone call between a call agent and the call recipient over a first two-party phone connection, comprising at least one computer including at least one processor programmed or configured to:
automatically add a third-party phone line to the two-party phone connection, the third-party phone line in communication with a call monitoring computer;
monitor, over the third-party phone line, the phone call;
detect a predefined response from at least one of the call recipient and the call agent over the phone call; and
automatically initiate a customer service action in response to detecting the predefined response.

12. The system of claim 11, wherein the at least one computer comprises the call monitoring computer.

13. The system of claim 11, wherein the third-party phone line is added to the phone call in response to an automated call system forwarding the phone call to the call agent.

14. The system of claim 11, wherein the customer service action comprises at least one of the following: adding a telephone number to an internal do-not-call list, adding a telephone number to an external do-not-call list, alerting a customer service representative, alerting a supervisor, logging an event in a database, or any combination thereof.

15. The system of claim 11, wherein the predefined response comprises at least one of the following: a key press, a predetermined sequence of a plurality of key presses, an audible phrase or term, or any combination thereof.

16. The system of claim 11, wherein monitoring the phone call comprises analyzing audio signals from the phone call to identify an audible phrase or term.

17. The system of claim 11, wherein the at least one computer comprises a call monitoring computer and a call computer, wherein the phone call is initiated or received through the call computer, and wherein at least one of the call monitoring computer and the call computer is programmed or configured to:
monitor the third-party phone line;
detect the predefined response from at least one of the individual and the call agent over the phone call; and
initiate the customer service action.

18. The system of claim 11, wherein the predefined response is detected from a plurality of predefined responses, each predefined response of the plurality of predefined responses corresponding to at least one customer service action.

19. A method for determining a status of a call recipient after or during a phone call between a call agent and the call recipient over a first phone line, comprising:
automatically recording the phone call, resulting in a call recording having a duration;
determining, with a computer, if the duration of the call recording exceeds a first predetermined call duration and is less than a second predetermined call duration;
in response to determining that the duration exceeds the first predetermined call duration and is less than the second predetermined call duration, determining if the call recording comprises at least one predefined response by analyzing the call recording; and
in response to determining that the call recording comprises the at least one predefined response, initiating at least one customer service action.

20. The method of claim 19, wherein the call recording processing system determines if the call recording comprises the at least one predefined response by analyzing the call recording.
